(19) United States
(12) Patent Application Publication
(10) Pub. No.: US 2026/0091350 A1
(43) Pub. Date: Apr. 2, 2026

(54) CARBON DIOXIDE RECOVERY DEVICE

(71) Applicant: DENSO CORPORATION, Kariya-city (JP)

(72) Inventor: Kenji OCHI, Kariya-city (JP)

(21) Appl. No.: 19/339,381

(22) Filed: Sep. 25, 2025

(30) Foreign Application Priority Data
Sep. 30, 2024 (JP) 2024-170373

(51) Int. Cl. B01D 53/32; B01D 53/62

(52) U.S. Cl. CPC B01D 53/326; B01D 53/62; B01D 2257/504; B01D 2258/06

(57) ABSTRACT

A carbon dioxide recovery device includes a stack formed by stacking a plurality of electrochemical cells in a pressurized state in a cell stacking direction of the electrochemical cells, which adsorb and desorb CO₂ from a CO₂-containing gas that contains CO₂ through an electrochemical reaction, a pair of supports arranged on one side and the other side of the cell stacking direction relative to the stack, and an elastic body provided between the pair of supports and having a larger Young's modulus than the electrochemical cells. The elastic body elastically deforms to apply a load to the plurality of electrochemical cells in the pressurized state in the cell stacking direction.

### CROSS REFERENCE TO RELATED APPLICATIONS

This application is based on Japanese Patent Application No. 2024-170373 filed on Sep. 30, 2024, the description of which is incorporated herein by reference.

### TECHNICAL FIELD

The present disclosure relates to a carbon dioxide recovery device.

### BACKGROUND

Conventionally, an electrochemical cell for separating gas species contained in a mixed gas has been proposed.

### SUMMARY

An object of the present disclosure is to provide a carbon dioxide recovery device that applies uniformly a load to each electrochemical cell.

In order to achieve the above object, a carbon dioxide recovery device includes:
a stack formed by stacking a plurality of electrochemical cells that adsorb and desorb CO₂ from a CO₂-containing gas containing CO₂ by an electrochemical reaction in a cell stacking direction of the plurality of electrochemical cells in a pressurized state;
a pair of supports arranged on one side and the other side in the cell stacking direction with respect to the stack; and
an elastic body provided between the pair of supports and having a Young's modulus greater than that of the electrochemical cell.

The elastic body elastically deforms to apply a load to the plurality of electrochemical cells in a pressurized state in the cell stacking direction.

### BRIEF DESCRIPTION OF DRAWINGS

FIG. 1 is a conceptual diagram illustrating an overall configuration of a carbon dioxide recovery system according to a first embodiment;

FIG. 2 is a perspective view showing the carbon dioxide recovery device;

FIG. 3 is a cross-sectional view showing a part of a laminated body in which a plurality of single-layer cells are stacked;

FIG. 4 is a cross-sectional view of a cell stack;

FIG. 5 is a cross-sectional view showing a method for fixing a columnar structure to another support;

FIG. 6 is a plan view for explaining a positioning of an electrochemical cell;

FIG. 7 is a cross-sectional view of a cell stack according to a second embodiment;

FIG. 8 is a perspective view showing another example of a cell stack according to the second embodiment;

FIG. 9 is a cross-sectional view of a plurality of cell stacks according to a fourth embodiment;

FIG. 10 is a cross-sectional view showing another example of a plurality of cell stacks according to the fourth embodiment;

FIG. 11 is a cross-sectional view showing an elastic body according to a fifth embodiment;

FIG. 12 is a cross-sectional view of a cell stack according to a sixth embodiment;

FIG. 13 is a cross-sectional view for explaining a load loss occurring when a load is applied to a laminated body at a clamping portion without disposing an elastic body; and

FIG. 14 is a cross-sectional view showing another example of the cell stack according to the sixth embodiment.

### DETAILED DESCRIPTION

In an assumable example, the electrochemical cell is arranged in a configuration into which the gas mixture can be introduced. As a configuration into which the mixed gas can be introduced, for example, a plate-shaped cell frame having an upper surface and a lower surface opposite to the upper surface can be used.

The electrochemical cell has a structure in which an insulating film is sandwiched between a working electrode and a counter electrode. For this reason, it is necessary to apply a load to the working electrode and the counter electrode in order to prevent the working electrode and the counter electrode from peeling off from the insulating film. When the load is small, the solution resistance of the electrochemical cell becomes high. This may result in a decrease in the amount of gas adsorbed by the electrochemical cell, which in turn may result in a decrease in the performance of the electrochemical cell.

A unit formed by a cell frame and an electrochemical cell is defined as a single-layer cell, and it is conceivable to provide a protrusion on a lower surface of the upper layer cell frame. A plurality of single-layer cells are then stacked in a vertical direction perpendicular to the upper surfaces of the cell frames so that the upper surface of the cell frame of the lower single-layer cell faces the lower surface of the cell frame of the upper single-layer cell.

As a result, the protrusion of the cell frame of the upper single-layer cell comes into contact with and press against the lower electrochemical cell. Thus, a load can be applied to each electrochemical cell. Furthermore, the solution resistance of the electrochemical cell decreases and stabilizes at a constant value. A space is provided between the lower single-layer cell and the upper single-layer cell. The mixed gas can contact the electrochemical cell by passing through the space.

However, due to variations in the height of each electrochemical cell, variations in the stacking of each electrochemical cell, and the like, the load may not be applied uniformly to each electrochemical cell. There is a possibility that the performance of each electrochemical cell may vary.

In view of the above possibility, an object of the present disclosure is to provide a carbon dioxide recovery device that can apply uniformly a load to each electrochemical cell.

In order to achieve the above object, a carbon dioxide recovery device includes:
a stack formed by stacking a plurality of electrochemical cells that adsorb and desorb CO₂ from a CO₂-containing gas containing CO₂ by an electrochemical reaction in a cell stacking direction of the plurality of electrochemical cells in a pressurized state;
a pair of supports arranged on one side and the other side in the cell stacking direction with respect to the stack; and
an elastic body provided between the pair of supports and having a Young's modulus greater than that of the electrochemical cell.

The elastic body elastically deforms to apply a load to the plurality of electrochemical cells in a pressurized state in the cell stacking direction.

The larger the Young's modulus, the less likely the material is to undergo creep deformation and the less likely stress relaxation is to occur. Therefore, even if the electrochemical cell is deformed in a crushing direction due to creep deformation, the elastic body undergoes stretching deformation. Thus, the load on the electrochemical cell can be compensated for. Furthermore, even if the load on the electrochemical cell is reduced due to stress relaxation, the elastic body is stretched and deformed. Therefore, the load of the electrochemical cell can be compensated for in this case as well. That is, even if the pressurized state of each electrochemical cell becomes uneven, a load based on the elastic body is additionally applied to each electrochemical cell in addition to the pressurized state of each electrochemical cell. In other words, a spring property of the elastic body acts in a direction that uniformizes the pressure applied to each electrochemical cell. Therefore, the load can be applied uniformly to each electrochemical cell.

The following describe embodiments for carrying out the present disclosure with reference to the drawings. In each embodiment, parts corresponding to the elements described in the preceding embodiments are denoted by the same reference numerals, and redundant explanation may be omitted. In each embodiment, when only a part of the configuration is described, another embodiment previously described can be employed for other parts of the configuration.

When, in each embodiment, it is specifically described that combination of parts is possible, the parts can be combined. In a case where any obstacle does not especially occur in combining the parts of the respective embodiments, it is possible to partially combine the embodiments, the embodiment and the modification, or the modifications even when it is not explicitly described that combination is possible.

### First Embodiment

Hereinafter, a first embodiment will be described with reference to the drawings. A carbon dioxide recovery device recoveries CO₂ from a CO₂-containing gas by an electrochemical reaction. The CO₂-containing gas is, for example, atmospheric air. In the present embodiment, a case where CO₂ is recovered from the atmosphere will be described.

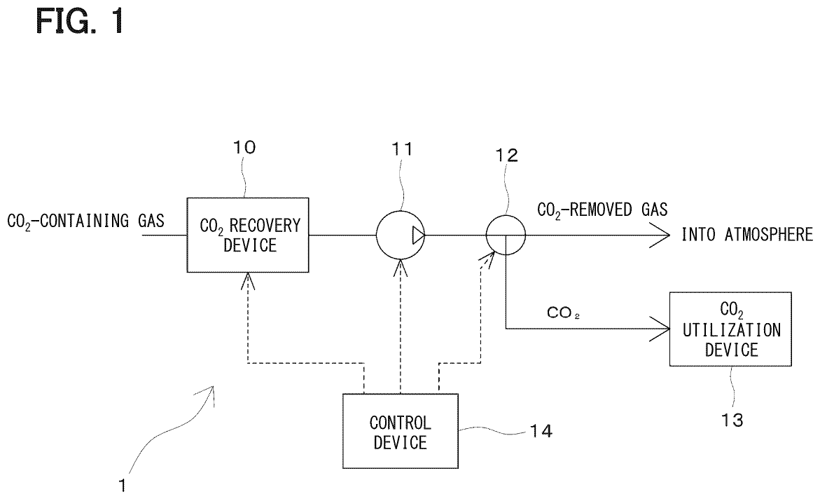

As shown in FIG. 1, a carbon dioxide recovery system 1 includes a carbon dioxide recovery device 10, a pump 11, a flow path switching valve 12, a carbon dioxide utilization device 13, and a control device 14. In the following description, the carbon dioxide recovery system 1, the carbon dioxide recovery device 10, and the carbon dioxide utilization device 13 will be referred to as the CO₂ recovery system 1, the CO₂ recovery device 10, and the CO₂ utilization device 13, respectively.

The CO₂ recovery device 10 is a device that separates and recoveries CO₂ from a CO₂-containing gas that contains CO₂. The CO₂-containing gas may be, for example, the atmosphere or exhaust gas from an internal combustion engine. The CO₂-containing gas also contains gases other than CO₂. The CO₂ recovery device 10 is supplied with a CO₂-containing gas and discharges a CO₂-removed gas after CO₂ has been recovered from the CO₂-containing gas, or discharges CO₂ recovered from the CO₂-containing gas. The configuration of the CO₂ recovery device 10 will be described in detail later.

The pump 11 supplies the CO₂-containing gas to the CO₂ recovery device 10 and discharges the CO₂ or CO₂-removed gas from the CO₂ recovery device 10. In the example shown in FIG. 1, the pump 11 is provided on the downstream side of the CO₂ recovery device 10 in the gas flow direction, but the pump 11 may be provided on the upstream side of the CO₂ recovery device 10 in the gas flow direction.

The flow path switching valve 12 is a three-way valve that switches a passage of exhaust gas from the CO₂ recovery device 10. The flow path switching valve 12 switches the passage of the exhaust gas toward the atmosphere when the CO₂-removed gas is discharged from the CO₂ recovery device 10, and switches the passage of the exhaust gas toward the CO₂ utilization device 13 when CO₂ is discharged from the CO₂ recovery device 10.

The CO₂ utilization device 13 is a device that utilizes CO₂. The CO₂ utilization device 13 may be a storage tank for storing CO₂ or a conversion device for converting CO₂ into fuel. As the conversion device, a device that converts CO₂ into a hydrocarbon fuel such as methane can be used. The hydrocarbon fuel may be gaseous fuel at normal temperature and pressure or liquid fuel at normal temperature and pressure.

The pump 11 may be provided between the flow path switching valve 12 and the CO₂ utilization device 13. In this case, the pump 11 is not operated during recovering CO₂, and the CO₂-containing gas is sent to the CO₂ recovery device 10 by the flow of outside air or by blowing air from a fan or the like. During CO₂ desorption, the pump 11 forcibly sends the CO₂ to the CO₂ utilization device 13 side.

The control device 14 includes a well-known microcontroller including a central processing unit (CPU), a read only memory (ROM), a random access memory (RAM) and the like, and peripheral circuits thereof. The control device 14 performs various calculations and processing based on control programs stored in the ROM, and controls operations of various control target devices. The control device 14 controls the operation of the CO₂ recovery device 10, the operation of the pump 11, and the flow path switching of the flow path switching valve 12, etc.

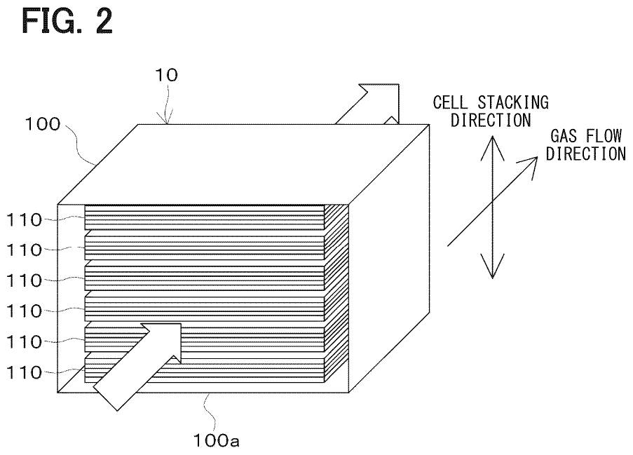

Next, the configuration of the CO₂ recovery device 10 of the present embodiment will be described with reference to FIGS. 2 to 6. In FIGS. 2 to 5, a direction from the near side of the paper surface to the far side of the paper surface is the gas flow direction, and a vertical direction of the paper surface is a cell stacking direction.

As shown in FIG. 2, the CO₂ recovery device 10 includes a storage unit 100. The storage unit 100 is configured in a box shape. The storage unit 100 can be made of, for example, a metal material. The storage unit 100 houses an electrochemical cell 110. The CO₂ recovery device 10 is configured to adsorb and desorb CO₂ via an electrochemical reaction of the electrochemical cell 110, thereby separating and recovering CO₂ from the CO₂-containing gas.

The storage unit 100 has two opening portions. These two opening portions are an inlet 100a for introducing a CO₂-containing gas into the inside, and an outlet (not shown) for discharging a CO₂ removal gas and CO₂ from the inside. The gas flow direction is the flow direction of the CO₂-containing gas when it passes through the storage unit 100, and is the direction from the inlet 100a of the storage unit 100 toward the outlet.

In FIG. 2, the CO₂-containing gas flows from the front side of the paper to the back side of the paper. Therefore, the near side in the drawing is the inlet 100a of the storage unit 100, and the far side in the drawing is the outlet of the storage unit 100. The inlet 100a and the outlet of the storage unit 100 may be provided with opening and closing members for opening and closing the inlet 100a and the outlet, respectively.

A plurality of electrochemical cells 110 are arranged at intervals within the storage unit 100. The cell stacking direction in which multiple electrochemical cells 110 are stacked is a direction orthogonal to the gas flow direction. Each electrochemical cell 110 is formed in a plate shape and is disposed such that a plate surface intersects the cell stacking direction.

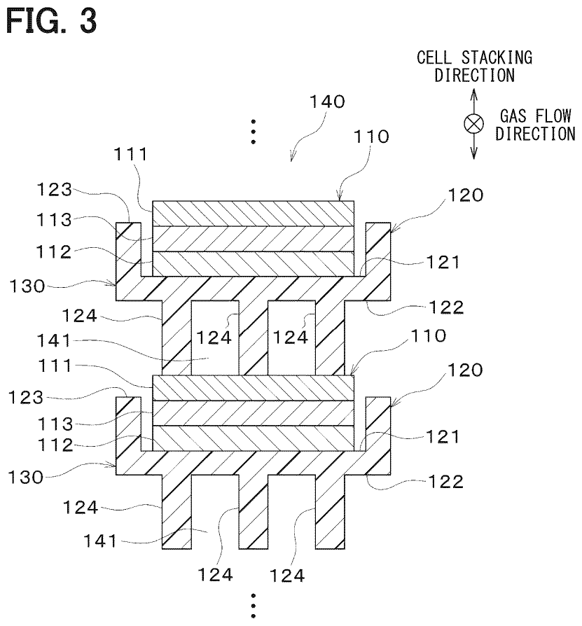

The electrochemical cell 110 is a device that can capture CO₂ by adsorbing CO₂ from the atmosphere through an electrochemical reaction, and also capture CO₂ by desorbing CO₂. As shown in FIG. 3, the electrochemical cell 110 has a working electrode 111, a counter electrode 112, and an insulating film 113. The working electrode 111, the counter electrode 112, and the insulating film 113 are configured, for example, in a plate shape.

The working electrode 111 includes a first current collector and a first electrode film. The first current collector is a porous conductive member that allows air to pass through.

The first current collector may be made of any material as long as it has gas permeability and electrical conductivity, and may be made of, for example, a metal material or a carbonaceous material. The first current collector may be, for example, a carbonaceous material or a metallic material. Examples of the carbonaceous material that can be used to form the first current collector include carbon paper, carbon cloth, nonwoven carbon mats, and porous gas diffusion layers (GDLs). The metal material constituting the first current collector may be, for example, a mesh structure made of metal such as Al, Ni, Ti, or SUS. Of course, the first current collector may be a porous metal body.

The first electrode film adsorbs and desorbs CO₂ from the air containing CO₂ through the electrochemical reaction. The first electrode film includes a CO₂ adsorbent, a working electrode-side conductive assistant, and a working electrode-side binder.

The CO₂ adsorbent adsorbs CO₂ by receiving electrons, and desorbs the adsorbed CO₂ by releasing electrons. As the CO₂ adsorbent, for example, polyanthraquinone can be used. Alternatively, carbon or metal oxides can be used as the CO₂ adsorbent.

The working electrode-side conductive assistant is a conductive material that forms a conductive path to the CO₂ adsorbent. As the working-electrode conductive assistant, for example, a carbon material such as carbon nanotube, carbon black, or graphene can be used.

The CO₂ adsorbent and the working electrode-side conductive assistant may be mixed by dissolving or dispersing the working electrode-side conductive assistant in an organic solvent such as NMP (N-methylpyrrolidone) and bringing the working electrode-side conductive assistant dispersed in the organic solvent into contact with the CO₂ adsorbent.

The working electrode-side binder is a holding material having adhesive strength. The working electrode-side binder holds the CO₂ adsorbent and the working electrode-side conductive assistant in the first current collector. This ensures the transfer of electrons among the first current collector, the CO₂ adsorbent, and the working electrode-side conductive assistant. In addition, the CO₂ adsorbent is less likely to peel off from the first current collector, and the amount of CO₂ adsorbed by the electrochemical cell 110 can be prevented from decreasing over time.

As the working electrode-side binder, a non-fluid material that does not have fluidity can be used. Non-fluid materials include gel-like materials and solid-like materials. As the gel-like material, for example, an ionic liquid gel can be used. As the solid-like material, for example, a solid electrolyte or a conductive resin can be used.

When a solid electrolyte is used as the working electrode-side binder, it is desirable to use an ionomer made of a polymer electrolyte or the like in order to increase the contact area with the CO₂ adsorbent. When a conductive resin is used as the working electrode-side binder, an epoxy resin containing Ag or the like as a conductive filler, or a fluororesin such as polytetrafluoroethylene (PTFE) or polyvinylidene fluoride (PVDF) can be used.

Then, a mixture of the CO₂ adsorbent, the working electrode-side conductive assistant, and the working electrode-side binder is formed, and this mixture is adhered to the first current collector. The CO₂ adsorbent and the working electrode-side conductive assistant are held in the working electrode-side binder. Therefore, the CO₂ adsorbent and the working electrode-side conductive assistant can be firmly held by the working electrode-side binder. In addition, the CO₂ adsorbent and the working electrode-side conductive assistant are less likely to peel off from the first current collector.

The first electrode film does not necessarily need to contain the working electrode-side binder. In other words, the first electrode film may have a binderless structure.

The counter electrode 112 has a second current collector and a second electrode film. The second current collector may be made of the same material as the first current collector, or may be made of a different material. For example, a metal plate can be used as the second current collector. The second current collector constituting the counter electrode 112 is disposed on an upper surface 121 of an insulating frame 120 which will be described later.

The second electrode film exchanges electrons with the first electrode film. The second electrode film has a counter electrode-side active material, a counter electrode-side conductive assistant, and a counter electrode-side binder.

The counter electrode-side active material is an auxiliary electroactive species that exchanges electrons with the CO₂ adsorbent of the first electrode film. The counter electrode-side active material is a material that can absorb and remove electrons by changing the valence of the metal or by inserting and removing charge into and from the TT-electron cloud.

As the counter electrode-side active material, for example, a metal complex that can donate and receive electrons by changing the valence of a metal ion can be used. Examples of the metal complex include cyclopentadienyl metal complexes such as ferrocene, nickelocene, and cobaltocene, porphyrin metal complexes, and the like. These metal complexes may be polymers or monomers.

The counter electrode-side conductive assistant is a conductive material that forms a conductive path to the counter electrode active material. The counter electrode-side conductive assistant is used by mixing with the counter electrode active material. The counter electrode-side conductive assistant may be made of the same material as the working electrode conductive assistant, or may be made of a different material. The counter electrode-side conductive assistant is, for example, in particulate form.

The counter electrode-side binder is a material that can hold the counter electrode-side active material and the counter electrode-side conductive assistant on the second current collector and has electrical conductivity. The counter electrode-side binder may be made of the same material as the working electrode-side binder, or may be made of a different material.

The second electrode film does not necessarily need to contain the counter electrode-side binder. In other words, the second electrode film may have a binderless structure.

The insulating film 113 is an insulating ion-permeable film that allows ions to pass therethrough. The insulating film 113 is disposed between the first electrode film of the working electrode 111 and the second electrode film of the counter electrode 112. The insulating film 113 is sandwiched between the first electrode film and the second electrode film, and separates the first electrode film from the second electrode film. That is, the insulating film 113 prevents physical contact between the first electrode film and the second electrode film. Moreover, the insulating film 113 suppresses an electrical short circuit between the first electrode film and the second electrode film.

The insulating film 113 can be made of a cellulose film, a polymer, a composite material of a polymer and ceramic, or the like. The insulating film 113 may be made of a porous material.

An ion conductive member may be provided between the first electrode film and the insulating film 113 or between the second electrode film and the insulating film 113. The ion conductive member facilitates electrical conduction to the CO₂ adsorbent material.

The electrochemical cell 110 is provided with a power supply (not shown) connected to a first current collector of the working electrode 111 and a second current collector of the counter electrode 112. The power supply applies a predetermined voltage to the working electrode 111 and the counter electrode 112 and can change the potential difference between the working electrode 111 and the counter electrode 112.

The electrochemical cell 110 operates in a switchable mode between a CO₂ recovery mode in which CO₂ is recovered by the working electrode 111 and a CO₂ discharge mode in which CO₂ is discharged from the working electrode 111 by changing the potential difference between the working electrode 111 and the counter electrode 112. The CO₂ recovery mode is a charging mode in which the electrochemical cell 110 is charged, and the CO₂ discharge mode is a discharging mode in which the electrochemical cell 110 is discharged.

In the CO₂ recovery mode, a first voltage V1 is applied between the working electrode 111 and the counter electrode 112, and electrons are supplied from the counter electrode 112 to the working electrode 111. At the first voltage V1, a working electrode potential is lower than a counter electrode potential. The first voltage V1 may be in the range of 0.5V to 2.0V, for example.

In the CO₂ discharge mode, the second voltage V2 is applied between the working electrode 111 and the counter electrode 112, and electrons are supplied from the working electrode 111 to the counter electrode 112. The second voltage V2 is a voltage different from the first voltage V1. The second voltage V2 may be any voltage lower than the first voltage V1.

For example, a reference electrode may be provided. In this case, for example, when the working electrode-counter electrode potential is +1 V and the working electrode-reference electrode potential is −1 V, the counter electrode-reference electrode potential is +2 V, that is, the working electrode potential is smaller than the counter electrode potential.

The CO₂ recovery device 10 also includes an insulating frame 120. The insulating frame 120 is a plate-shaped component having an upper surface 121 and a lower surface 122 opposite to the upper surface 121. The electrochemical cell 110 is disposed on the upper surface 121 of the insulating frame 120.

The insulating frame 120 is a resin molded product made of a highly rigid insulating resin material such as polypropylene. The upper surface 121 is, for example, rectangular. The upper surface 121 may have other shapes besides a rectangle.

The insulating frame 120 has a wall portion 123 that protrudes from a part of the upper surface 121 along the cell stacking direction. The wall portions 123 are provided along the gas flow direction at both ends of the upper surface 121 in a direction perpendicular to the gas flow direction. The height of the wall portion 123 from the upper surface 121 is lower than that of the electrochemical cell 110. The height of the wall portion 123 is merely an example, and it may be the same height as the electrochemical cell 110 or higher than the electrochemical cell 110. The wall portion 123 may be a separate body from the plate-shaped portion.

The insulating frame 120 also has leg portions 124 that protrude from a portion of the lower surface 122 in the cell stacking direction. The leg portion 124 is for pressing a part of the lower electrochemical cell 110 in the cell stacking direction. For example, the leg portions 124 are integrally molded into the lower surface 122.

The leg portion 124 does not need to protrude at 90° with respect to the lower surface 122, and may be inclined with respect to the lower surface 122. Furthermore, the leg portions 124 do not have to be integrated with the lower surface 122 of the insulating frame 120, and may be separate from the plate-shaped portion. Furthermore, the length (width) of the leg portion 124 in the direction perpendicular to the cell stacking direction does not have to be constant. In other words, the thickness of the leg portion 124 does not need to be constant in the cell stacking direction.

Here, a unit of the insulating frame 120 and the electrochemical cell 110 is defined as a single-layer cell 130. A plurality of single-layer cells 130 are stacked in the cell stacking direction. As a result, the multiple single-layer cells 130 form a stack 140 of single-layer cells 130.

Furthermore, each electrochemical cell 110 is pressed down by the leg portions 124 of the insulating frame 120 in the upper layer, and is therefore stacked in the pressurized state in the cell stacking direction. A plurality of electrochemical cells 110 are stacked together, so that pressure is applied from the upper layers. The direction in which the working electrodes 111 and the like of each electrochemical cell 110 are stacked is the same as the cell stacking direction in which the multiple electrochemical cells 110 are stacked.

A flow path for passing air is formed between a single-layer cell 130 located on the lower side and a single-layer cell 130 located on the upper side among the plurality of single-layer cells 130. The width of the flow path is a distance between the electrochemical cell 110 of the single-layer cell 130 located on the lower layer side and the lower surface 122 of the insulating frame 120 of the single-layer cell 130 located on the upper layer side. The air passes through a space 141 that corresponds to the width of the flow path.

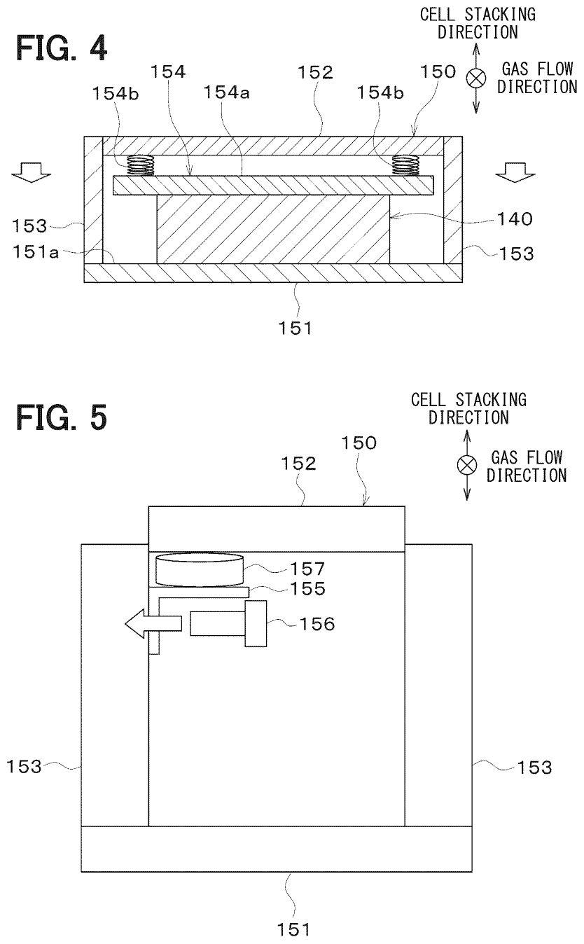

In the above configuration, the stack 140 is part of a cell stack. As shown in FIG. 4, the cell stack 150 is composed of the stack 140, a pair of supports 151 and 152, a plurality of columnar structures 153, and an elastic portion 154. The cell stack 150 is accommodated in the storage unit 100.

The pair of supports 151, 152 are plate members arranged on one side and the other side of the stack 140 in the cell stacking direction of the multiple electrochemical cells 110. One support 151 is a bottom plate, and the other support 152 is a top plate.

One support 151 has a surface 151a facing the other support 152. The multiple columnar structures 153 are supports for maintaining the distance between the pair of supports 151 and 152. A plurality of columnar structures 153 are fixed to one surface 151a of one support 151. The multiple columnar structures 153 are perpendicular to one surface 151a of one support 151 and extend in the cell stacking direction. The pair of supports 151 and 152 and the columnar structure 153 are made of, for example, metal or resin.

The other support 152 is fixed to the columnar structure 153 on the side opposite to the side of the one support 151. As shown in FIG. 5, the columnar structure 153 and the other support 152 are not directly fixed to each other. The columnar structure 153 and the other support 152 are indirectly fixed together by a metal fitting 155, a bolt 156, and a spring 157.

The metal fitting 155 is, for example, an L-shaped metal fitting. The metal fitting 155 is not limited to an L-shaped metal fitting, but may be a metal fitting of another shape. The spring 157 is, for example, a coil spring, a disc spring, a leaf spring, or the like. The bolts 156 secure the metal fitting 155 to the side wall surface of the columnar structure 153. One end of the spring 157 can be fixed to the other support 152 and the other end of the spring 157 can be fixed to the other support 152 by, for example, welding, adhesion, mechanical fastening using clips, or the like. Alternatively, the spring 157 may not be fixed. For example, the spring 157 may be sandwiched between the other support 152 and the metal fitting 155 by the pressing force of the spring 157 alone.

In addition, FIG. 5 shows one fixed portion. In reality, the metal fitting 155 is fixed to each columnar structure 153. In FIG. 5, the stack 140 and the elastic portion 154 are omitted. Moreover, in drawings showing cross sections other than FIG. 4 and FIG. 5, the metal fitting 155, the bolt 156, and the spring 157 are omitted.

In the present embodiment, the orthogonal surfaces of the pair of supports 151 and 152 that are orthogonal to the cell stacking direction have a rectangular shape. The columnar structures 153 are disposed at the four corners of the orthogonal faces of each of the supports 151 and 152. Each electrochemical cell 110 is positioned between a pair of supports 151 and 152. For positioning, it is sufficient to have a seating surface for each electrochemical cell 110 and positioning surfaces in two directions among the planar directions of the seating surface.

The seating surface of the electrochemical cell 110 to be positioned is the single-layer cell 130 located in the lower layer. The seating surface of the single-layer cell 130 (electrochemical cell 110) in the bottom layer is one support 151. The positioning surfaces in two directions are the side wall surfaces of the columnar structure 153. That is, each electrochemical cell 110 is positioned by contacting the side wall surfaces of at least two columnar structures 153 located in different directions among plane directions parallel to a plane perpendicular to the cell stacking direction. The single-layer cell 130 in the bottom layer may be positioned by a groove provided in the support 151.

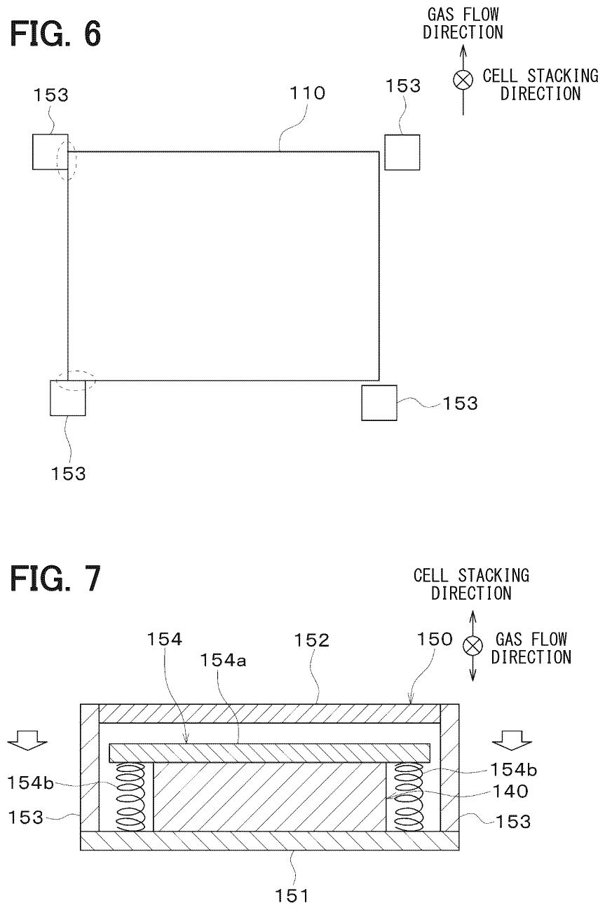

As shown in FIG. 6, the stack 140 is in contact with the sidewall surfaces of two of the four columnar structures 153. In the present embodiment, one direction of the two different directions is the gas flow direction, and the other direction is a direction perpendicular to the gas flow direction and the cell stacking direction.

The stack 140 is formed by stacking the electrochemical cells 110 and the insulating frames 120 alternately. Therefore, depending on the shape of the insulating frame 120, the insulating frame 120 may come into contact with the columnar structures 153, thereby indirectly positioning each electrochemical cell 110. In other words, the object to be positioned may be the insulating frame 120 instead of the electrochemical cell 110. Alternatively, the target to be positioned may be the single-layer cell 130.

By positioning each electrochemical cell 110, it is possible to avoid a load from being applied inappropriately to some of the electrochemical cells 110. Furthermore, the elastic portion 154 allows a uniform load to be applied to all the electrochemical cells 110.

As shown in FIG. 4, the elastic portion 154 is disposed between the pair of supports 151, 152 and is a component for applying a load in the cell stacking direction to each of the electrochemical cells 110 constituting the stack 140. In the present embodiment, as shown in FIG. 4, the elastic portion 154 has a plate portion 154a and an elastic body 154b.

The plate portion 154a is a plate member disposed between the other support 152 and the stack 140. The plate portion 154a is in contact with the electrochemical cell 110 in the uppermost layer of the stack 140. The plate portion 154a may be made of a metal plate such as stainless steel or aluminum, or a high-density resin plate.

The elastic body 154b is a component that applies pressure to the stack 140 by applying a load to the stack 140 in the cell stacking direction. In the present embodiment, a plurality of elastic bodies 154b are provided between the other support 152 and the plate portion 154a in a space between the pair of supports 151, 152 and are fixed to the other support 152 and the plate portion 154a.

The elastic body 154b is a spring material such as a compression coil spring or a leaf spring made of metal, resin, or the like. The number of elastic bodies 154b is appropriately selected based on the size, shape, strength, material, etc. of the elastic bodies 154b. The elastic body 154b may be made of a stretchable resin material such as rubber.

For example, when the elastic body 154b is made of a metallic material, it is made of a material containing at least one of stainless steel, high carbon steel, and nickel. These metal materials are used as spring. Stainless steel is an excellent material in terms of corrosion resistance. The Young's modulus of SUS304 is, for example, 193 GPa. The Young's modulus of the nickel material is, for example, 199 GPa to 220 GPa.

The elastic body 154b is disposed in a compressed state between the other support 152 and the plate portion 154a. Therefore, the elastic body 154b is elastically deformed so as to extend in the cell stacking direction, thereby transmitting a force to the plate portion 154a in the cell stacking direction. That is, the elastic body 154b applies a restoring force to the plate portion 154a to return it to its original shape from a crushed state. The plate portion 154a applies a force transmitted from the elastic body 154b, that is, a restoring force, to the electrochemical cell 110 in the uppermost layer of the stack 140. As a result, the load of the elastic body 154b is applied to the entirety of each electrochemical cell 110. In other words, the load refers to the load on the contact surface of the plate portion 154a of the electrochemical cell 110.

It is not necessary for the elastic body 154b to be directly connected to both the other support 152 and the plate portion 154a. For example, the elastic body 154b may be connected to a protrusion provided on the other support 152 or the plate portion 154a. The protrusion may be provided on either the other support 152 or the plate portion 154a, or on both. Furthermore, the load of the spring 157 for supporting the other support 152 may be applied directly or indirectly to the stack 140.

Here, the Young's modulus of the elastic body 154b is greater than the Young's modulus of the electrochemical cell 110. The larger the Young's modulus of a material, the smaller the amount of creep deformation. The electrochemical cell 110 is subject to creep deformation due to its materials of construction. Therefore, when the Young's modulus of the elastic body 154b is greater than the Young's modulus of the electrochemical cell 110, the elastic body 154b has an elastic range that is equal to or greater than the creep deformation of the electrochemical cell 110. As a result, the elastic body 154b can keep the load applied to each electrochemical cell 110 constant via the plate portion 154a.

The above is the overall configuration of the CO₂ recovery system 1 and the CO₂ recovery device 10 according to the present embodiment.

Next, the operation of the CO₂ recovery system 1 will be described. As described above, the CO₂ recovery system 1 operates by alternately switching between the CO₂ recovery mode and the CO₂ discharge mode. The operation of the CO₂ recovery system 1 is controlled by the control device 14.

First, the CO₂ recovery mode will be described. In the CO₂ recovery, the door of the CO₂ recovery device 10 is opened and outside air is introduced into the CO₂ recovery device 10. This causes the CO₂-containing gas to be supplied to the CO₂ recovery device 10. In the CO₂ recovery device 10, a voltage applied between the working electrode 111 and the counter electrode 112 of the electrochemical cell 110 is defined as a first voltage V1. As a result, the electron donation of the electroactive auxiliary material of the counter electrode 112 and the electron attraction of the CO₂ adsorbent of the working electrode 111 can be realized at the same time.

The CO₂ adsorbent of the working electrode 111 that has received electrons from the counter electrode 112 has a stronger bond with CO₂, and adsorbs and bonds with the CO₂ contained in the CO₂-containing gas. Thus, the CO₂ recovery device 10 can recover CO₂ from the CO₂-containing gas. The CO₂-removed gas from which CO₂ has been removed is discharged from the CO₂ recovery device 10.

In the CO₂ recovery mode, the control device 14 switches the flow path switching valve 12 so that the CO₂-removed gas discharged from the CO₂ recovery device 10 flows into the atmosphere. As a result, the CO₂-removed gas discharged from the CO₂ recovery device 10 is discharged into the atmosphere.

Next, the CO₂ discharge mode will be described. In the CO₂ discharge mode, the control device 14 stops the pump 11. As a result, the supply of CO₂-containing gas to the CO₂ recovery device 10 is stopped. In the CO₂ recovery device 10, a voltage applied between the working electrode 111 and the counter electrode 112 of the electrochemical cell 110 is defined as a second voltage V2. As a result, the electron attraction of the CO₂ adsorbent of the working electrode 111 and the electron donation of the electroactive auxiliary material of the counter electrode 112 can be realized at the same time.

The CO₂ adsorbent of the working electrode 111 releases electrons and becomes oxidized. The binding strength of the CO₂ adsorbent to carbon dioxide decreases, and the CO₂ is desorbed and released. The CO₂ released from the CO₂ adsorbent is discharged from the CO₂ recovery device 10.

In the CO₂ discharge mode, the control device 14 switches the flow path switching valve 12 so that the CO₂ discharged from the CO₂ recovery device 10 flows out to the inlet side of the CO₂ utilization device 13. As a result, the CO₂ discharged from the CO₂ recovery device 10 is supplied to the CO₂ utilization device 13.

In addition, in a system in which the pump 11 is provided between the flow path switching valve 12 and the CO₂ utilization device 13, in the CO₂ recovery mode, the control device 14 does not operate the pump 11, but sends CO₂-containing gas to the CO₂ recovery device 10 by using the flow of outside air or fan blowing, etc. In addition, in the CO₂ discharge mode, the control device 14 operates the pump 10 to forcibly send CO₂ to the CO₂ utilization device 13 side.

As described above, according to the CO₂ recovery system 1 of the present embodiment, it is possible to capture CO₂ from the CO₂-containing gas and to effectively utilize the captured CO₂.

In the present embodiment, the CO₂ recovery device 10 is configured so that a load is further applied to each electrochemical cell 110, which is already in a pressurized state due to the multiple stacked electrochemical cells 110, by the elastic deformation of the elastic body 154b. As a result, even if there is variation in the height of each electrochemical cell 110 or in the stacking of each electrochemical cell 110, a load based on the elastic body 154b is additionally applied to each electrochemical cell 110. Therefore, even if the pressurized state of each electrochemical cell 110 becomes uneven due to creep deformation or stress relaxation, the spring properties of the elastic body 154b can make the pressurized force applied to each electrochemical cell 110 uniform. Therefore, the load can be applied uniformly to each electrochemical cell 110. Moreover, the performance of each electrochemical cell 110 can be made uniform.

As another example, the elastic portion 154 may be disposed between the stack 140 and one of the supports 151. In this case, the elastic portion 154 can apply an additional load based on the elastic body 154b to each of the electrochemical cells 110 constituting the stack 140 by pressing the stack 140 from below to above.

As another example, the elastic portion 154 does not have to have the plate portion 154a. In this case, the elastic body 154b is disposed between the other support 152 and the uppermost single-layer cell 130, and the elastic body 154b directly presses the single-layer cell 130 in the uppermost layer in the cell stacking direction. Alternatively, the elastic body 154b is disposed between one of the supports 151 and the single-layer cell 130 in the lowermost layer, and the elastic body 154b directly presses the single-layer cell 130 in the lowermost layer in the cell stacking direction.

### Second Embodiment

In the present embodiment, the configurations different from those of the first embodiment will be mainly described. As shown in FIG. 7, the elastic body 154b is provided between the plate portion 154a and one of the supports 151 between the pair of supports 151, 152, and is fixed to the plate portion 154a and one of the supports 151.

The elastic body 154b is disposed between the plate portion 154a and one of the supports 151 in a stretched state. Therefore, the elastic body 154b is elastically deformed so as to contract in the cell stacking direction, thereby transmitting a force to the plate portion 154a in the cell stacking direction.

As described above, by applying a load to each electrochemical cell 110 by utilizing the force acting to contract the elastic body 154b, the same effects as those of the first embodiment can be obtained.

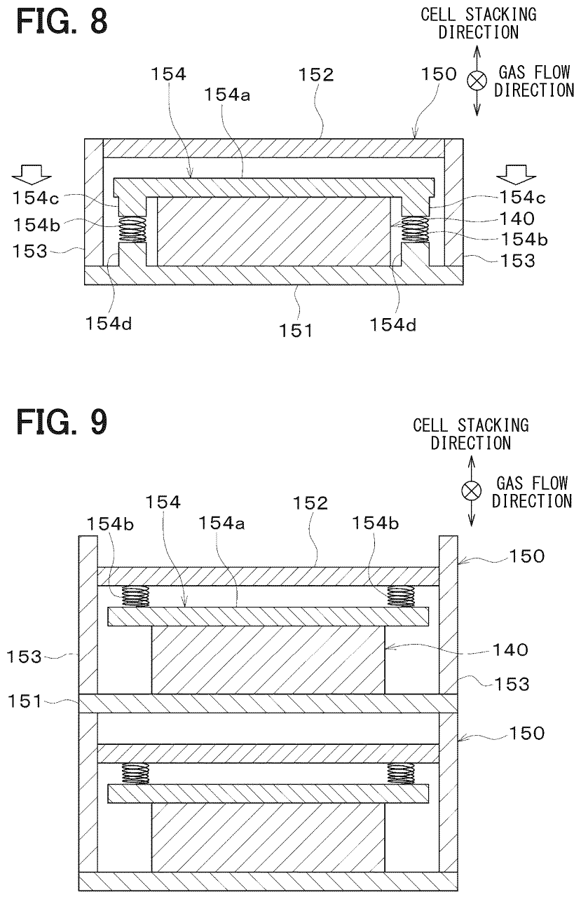

As another example, as shown in FIG. 8, the plate portion 154a has one connection portion 154c protruding toward one support 151 side. One support 151 has the other connection portion 154d protruding toward the plate portion 154a. The elastic body 154b may be disposed between the one connection portion 154c and the other connection portion 154d, and may be connected to each of the connection portions 154c and 154d.

Alternatively, the plate portion 154a may not have one of the connection portions 154c, and one of the supports 151 may have the other of the connection portions 154d, and the elastic body 154b may be disposed between the plate portion 154a and the other of the connection portions 154d and connected to the plate portion 154a and the other of the connection portions 154d. Alternatively, the plate portion 154a may have one connection portion 154c, the one support 151 may not have the other connection portion 154d, and the elastic body 154b may be arranged between the one connection portion 154c and the one support 151 and connected to the one connection portion 154c and the one support 151. In this way, the elastic body 154b does not have to be directly connected to both the plate portion 154a and the one support 151.

As another example, the elastic portion 154 may be disposed between the stack 140 and one of the supports 151. In this case, the stack 140 is sandwiched between the other support 152 and the plate portion 154a and is floating above the one support 151.

### Third Embodiment

In the present embodiment, portions different from those of the first and second embodiments will be mainly described. In the present embodiment, the elastic body 154b is included in the electrochemical cell 110. For example, the elastic body 154b constitutes a first current collector of the working electrode 111 or a second current collector of the counter electrode 112 that constitutes the electrochemical cell 110. The elastic body 154b may be provided only on the working electrode 111 or only on the counter electrode 112.

The elastic body 154b is, for example, a nonwoven fabric made of SUS (SUS felt). The SUS nonwoven fabric is made of SUS metal fibers intertwined in layers. The SUS nonwoven fabric is produced by compressing and molding fibrous SUS. It can be said that the SUS nonwoven fabric constitutes an assembly of SUS fine wire springs. Of course, the nonwoven fabric may be made of a metal material other than SUS. With the above configuration, the same effects as in the first embodiment can be obtained.

The elastic body 154b may be disposed above or below the electrochemical cell 110 as a separate body from the electrochemical cell 110. In this case, the elastic body 154b may be disposed only on the upper side of the electrochemical cell 110, or may be disposed only on the lower side of the electrochemical cell 110.

The elastic body 154b is not limited to felt made of a metal material. The elastic body 154b may be made of a resin material such as plastic or rubber in a layered form. Moreover, the electrochemical cell 110 including the elastic body 154b is not electrically connected to the electrochemical cell 110 directly above or directly below via the elastic body 154b.

### Fourth Embodiment

In the present embodiment, the configurations different from the respective embodiments described above will be described. As shown in FIG. 9, in the present embodiment, a plurality of cell stacks 150 are stacked in the cell stacking direction. Furthermore, in each cell stack 150, the elastic body 154b is provided in the cell stack 150 so as not to bear the load of one of the supports 151 of the cell stack 150 in the upper layer.

Specifically, the other support 152 is located closer to the one support 151 than the upper ends of each columnar structure 153, and is bolted in a direction perpendicular to the cell stacking direction as described above. The cell stack 150 in the upper layer is stacked on top of each of the columnar structures 153 that make up the lower cell stack 150.

The elastic body 154b is connected only to the electrochemical cell 110 in the uppermost layer in the stack 140. Here, the term “connected” means that only the load based on the elastic body 154b is applied to the electrochemical cell 110 in the uppermost layer. Therefore, the elastic body 154b applies a load to the electrochemical cell 110 in the uppermost layer in the stack 140 without receiving the load of the cell stack 150 in the upper layer.

With the above-described configuration, in a stack of multiple cell stacks 150, the electrochemical cells 110 located in the cell stacks 150 on the lower layer side can receive an appropriate load from the elastic body 154b without being affected by the weight of the cell stacks 150 located in the upper layers. The same applies to the cell stack 150 shown in the second and third embodiments.

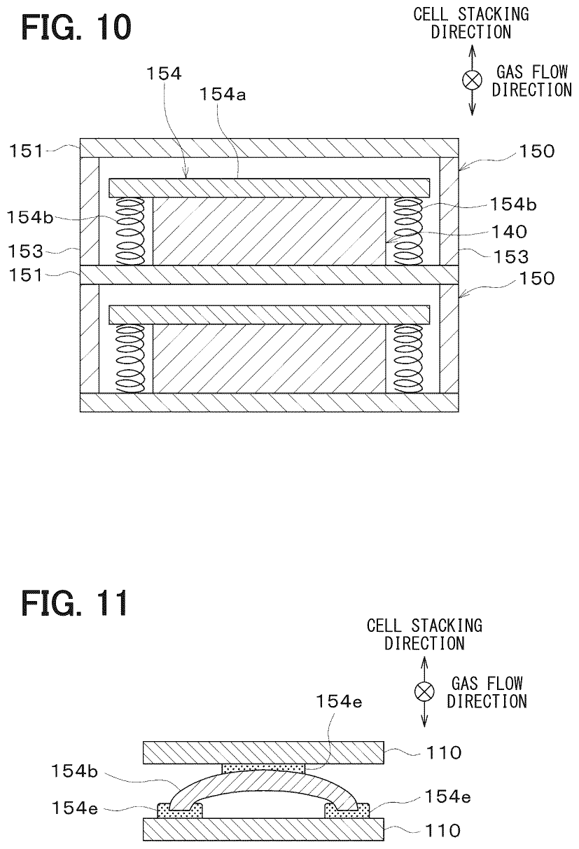

As another example, as shown in FIG. 10, in the cell stacks 150 located above and below among a plurality of cell stacks 150, one support 151 of the cell stack 150 located above and one support 152 of the cell stack 150 located below may be made common. By using the supports 151 and 152 in common, the other support 152 can be eliminated.

Even if the upper and lower supports 151, 152 are used in common, the cell stack 150 on the upper side is supported by the columnar structure 153 on the lower side. Therefore, the elastic body 154b is not affected by the load of the cell stack 150 on the upper side. The same applies to the cell stack 150 shown in the second and third embodiments.

### Fifth Embodiment

In the present embodiment, the configurations different from the respective embodiments described above will be described. In the present embodiment, a leaf spring is used as the elastic body 154b.

As shown in FIG. 11, the elastic body 154b is sandwiched between the upper and lower electrochemical cells 110 which are stacked. At least the portion of the elastic body 154b serving as a leaf spring that comes into contact with the electrochemical cell 110 is made of an insulating material 154e. The insulating material 154e is an electrically insulating material such as insulating paint or a resin material.

With such configuration, it is possible to prevent the elastic body 154b from coming into contact with the upper and lower electrochemical cells 110. Furthermore, the elastic body 154b and the insulating material 154e can apply a load to the upper and lower electrochemical cells 110 while electrically insulating the upper and lower electrochemical cells 110 from each other.

A disc spring may be used as the elastic body 154b. Disc springs and leaf springs have the advantage that the thickness in the cell stacking direction can be minimized compared to coil springs and spiral springs. Moreover, the elastic body 154b may be entirely covered with an insulating material 154e. Alternatively, the elastic body 154b itself may be made of the insulating material 154e. Of course, the elastic body 154b according to the present embodiment may be applied to each of the above embodiments.

### Sixth Embodiment

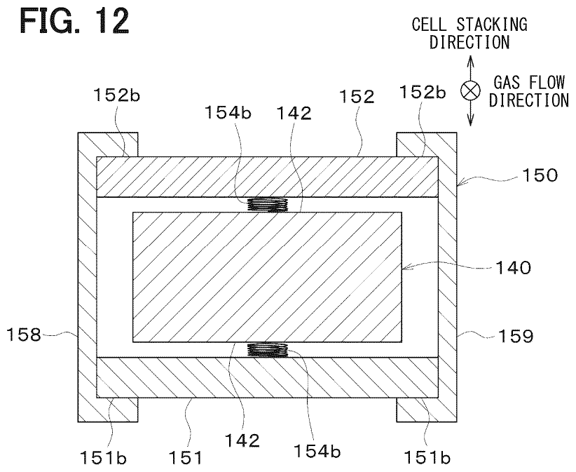

In the present embodiment, the configurations different from the respective embodiments described above will be described. In the present embodiment, as shown in FIG. 12, the cell stack 150 is made up of the stack 140, a pair of supports 151, 152, the elastic body 154b, and a set of clamping portions 158, 159. The cell stack 150 may or may not have the columnar structures 153.

In a state where the stack 140 is positioned between the pair of supports 151, 152, the clamping portions 158, 159 clamp and fix the outer edge portions 151b, 152b of the pair of supports 151, 152 in a direction perpendicular to the cell stacking direction in the cell stacking direction. The clamping portions 158, 159 are arranged as a pair, for example, in a direction perpendicular to the cell stacking direction and the gas flow direction. The clamping portions 158, 159 are fixed to the pair of supports 151, 152 by screws, for example.

In the present embodiment, the elastic body 154b is disposed on the outermost side of the stack 140 in the cell stacking direction. For example, the elastic bodies 154b are disposed on one side or both sides in the cell stacking direction. In other words, the stack 140 is sandwiched between the two elastic bodies 154b.

The outermost portion of the stack 140 in the cell stacking direction is subjected to the cumulative creep deformation of each electrochemical cell 110 and is therefore considered to be subject to the largest load fluctuation. Therefore, by disposing the elastic body 154b on the outermost portion of the stack 140, it becomes possible to accommodate the accumulated creep deformation. Therefore, the efficiency of the load application to each electrochemical cell 110 is maximized.

The elastic body 154b is disposed in the central portion 142 of the stack 140 in the direction perpendicular to the cell stacking direction. Here, the central portion 142 is a predetermined region that includes the center of a surface of the stack 140 that is perpendicular to the cell stacking direction. The central portion 142 can also be said to be a region of the stack 140 that does not include the outer edge of the surface perpendicular to the cell stacking direction. In other words, the elastic body 154b is disposed at a position away from the clamping portions 158, 159.

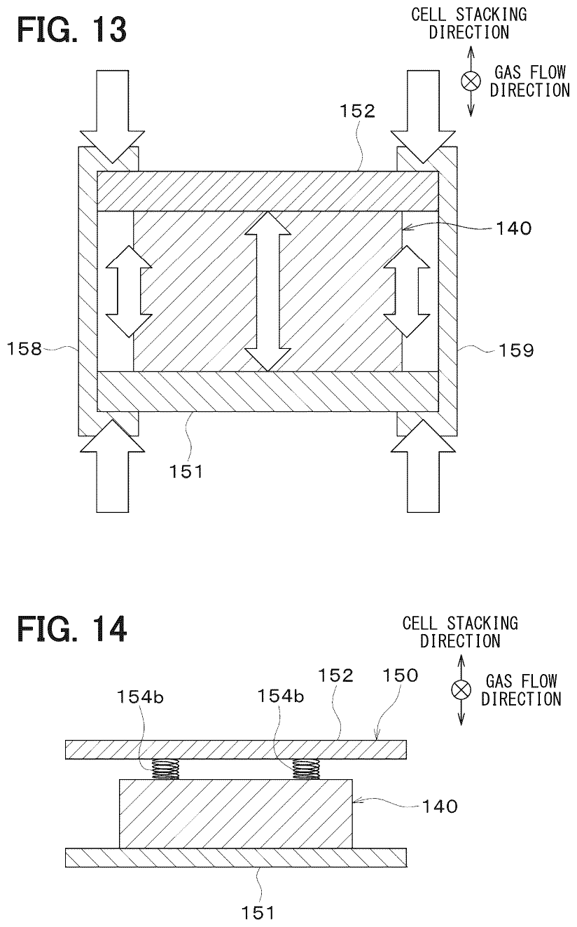

As shown in FIG. 13, in a configuration in which the outer edge portions 151b, 152b of a pair of supports 151, 152 are clamped by the clamping portions 158, 159, the load of the clamping portions 158, 159 is applied to the outer edge portions 151b, 152b, while the load of the clamping portions 158, 159 is less likely to be applied to positions away from the outer edge portions 151b, 152b. In addition, the elastic body 154b is omitted in FIG. 13.

Therefore, in the direction perpendicular to the cell stacking direction and the gas flow direction, a difference occurs in the magnitude of the load in the cell stacking direction between the end portions and the central portion 142 of the stack 140. In this way, the load of the clamping portions 158, 159 is less likely to be applied to positions of the stack 140 that are distant from the clamping portions 158, 159, and therefore there is a possibility that a loss of load will occur.

In contrast, in the present embodiment, as shown in FIG. 12, the elastic body 154b is disposed in the central portion 142 of the stack 140 in a direction perpendicular to the cell stacking direction, so that the application of the load to the stack 140 is maintained by the reaction force of the elastic body 154b. Therefore, the load loss due to the clamping portions 158 and 159 can be efficiently prevented.

As another example, as shown in FIG. 14, the elastic body 154b may be disposed on only one side in the cell stacking direction. In other words, the stack 140 does not have to be sandwiched between two elastic bodies 154b. The number of elastic bodies 154b may be one or more. In FIG. 14, the clamping portions 158, 159 and the columnar structure 153 are omitted.

### Other Embodiments

The configuration of the CO₂ recovery device 10 shown in each of the above embodiments is merely an example, and the present disclosure is not limited to the above-described configuration, and other configurations are possible that can realize the present disclosure. For example, the CO₂-containing gas is not limited to the air, but may be any gas that contains CO₂.

As long as the pair of supports 151, 152 can be held, the columnar structure 153 does not have to be provided between the pair of supports 151, 152. For example, the pair of supports 151 and 152 may be fixed inside the storage unit 100.

FIGS. 9 and 10 show a case where the cell stack 150 is in two stages, but this configuration is just one example. Of course, the cell stack 150 may be stacked in three or more stages.

What is claimed is:

1. A carbon dioxide recovery device, comprising:
a stack formed by stacking a plurality of electrochemical cells that adsorb and desorb CO₂ from a CO₂-containing gas containing CO₂ by an electrochemical reaction in a cell stacking direction of the plurality of electrochemical cells in a pressurized state;
a pair of supports arranged on one side and the other side in the cell stacking direction with respect to the stack; and
an elastic body provided between the pair of supports and having a Young's modulus greater than that of the electrochemical cell;
wherein
the elastic body applies a load to the plurality of electrochemical cells in a pressurized state in the cell stacking direction by elastically deforming.

2. The carbon dioxide recovery device according to claim 1, wherein
at least a portion of the elastic body that contacts the electrochemical cell is electrically insulated.

3. The carbon dioxide recovery device according to claim 1, further comprising,
a clamping portion that clamps and fixes outer edge portions of the pair of supports in a direction perpendicular to the cell stacking direction in a state in which the stack is disposed between the pair of supports in the cell stacking direction, wherein
the elastic body is disposed in a central portion of the stack in a direction perpendicular to the cell stacking direction.

4. The carbon dioxide recovery device according to claim 1, wherein
the elastic body is disposed on an outermost side of the stack in the cell stacking direction.

5. The carbon dioxide recovery device according to claim 1, wherein
the elastic body is a disc spring or a leaf spring.

6. The carbon dioxide recovery device according to claim 1, wherein
the elastic body is made of a material containing at least one of a stainless steel material, a high carbon steel, and a nickel material.

7. The carbon dioxide recovery device according to claim 1, wherein
one support of the pair of supports has a surface facing the other support of the pair of supports,
a plurality of columnar structures are fixed to the surface of the one support, are perpendicular to the surface of the one support, and extend in the cell stacking direction,
the other support is fixed to the columnar structure on a side opposite to the one support, and
the plurality of electrochemical cells are positioned by contacting at least two of the columnar structures that are positioned in different directions among planar directions parallel to a plane perpendicular to the cell stacking direction.

8. The carbon dioxide recovery device according to claim 1, wherein
one support of the pair of supports has a surface facing the other support of the pair of supports,
a plurality of columnar structures are fixed to the surface of the one support, are perpendicular to the surface of the one support, and extend in the cell stacking direction,
the other support is fixed to the columnar structure on a side opposite to the one support,
when a set of the stack, a pair of the supports, and the plurality of columnar structures is defined as a cell stack, the plurality of cell stacks are stacked in the cell stacking direction, and
the elastic body applies a load to the electrochemical cell in an uppermost stage of the stack without receiving a load from the support of the one of the cell stacks in an upper layer.

9. The carbon dioxide recovery device according to claim 8, wherein
one support of the cell stack located at an upper side among the plurality of cell stacks and the other support of the cell stack located at a lower side are shared.
